(19) United States
(12) Patent Application Publication
(10) Pub. No.: US 2025/0051690 A1
(43) Pub. Date: Feb. 13, 2025

(54) FUNCTIONALISED POLYSACCHARIDE

(71) Applicant: Reckitt Benckiser Finish B.V., Hoofddorp (NL)

(72) Inventors: Alias Younis Al-Bayati, Heidelberg (DE); Marco Haag, Heidelberg (DE); Torsten Roth, Heidelberg (DE); Divya Varadharajan, Heidelberg (DE); Nils Wedler, Heidelberg (DE); Qingcai Zhao, Heidelberg (DE)

(21) Appl. No.: 18/719,955

(22) PCT Filed: Dec. 15, 2022
(86) PCT No.: PCT/EP2022/086125

§ 371 Date: Jun. 14, 2024

(30) Foreign Application Priority Data
Dec. 15, 2021 (GB) 2118132.6

(51) Int. Cl. C11D 3/22; C08B 31/12; C11D 17/04

(52) U.S. Cl. CPC C11D 3/228; C08B 31/12; C11D 17/045

(57) ABSTRACT

A polysaccharide for a detergent formulation, wherein the polysaccharide comprises a poly saccharide backbone functionalised with carboxylic acid groups, or salts or esters thereof, and sulfur-containing groups, or salts or esters thereof.

### TECHNICAL FIELD OF THE INVENTION

The present invention relates to a functionalised polysaccharide for a detergent formulation. In particular, the invention relates to a functionalised polysaccharide which provides consumer-related benefits, in particular in preventing limescale formation. The invention further relates to a detergent formulation comprising the functionalised polysaccharide, and to uses of the functionalised polysaccharide and detergent formulation.

### BACKGROUND TO THE INVENTION

It is known to provide a detergent formulation comprising one or more cleaning actives, for example one or more polymers, associated with the improvement of filming and spotting in the context of limescale formation. Conventional polymers for preventing limescale formation are based on acrylic chemistry. Such conventional polymers may include polycarboxylates, such as polyacrylic acid (PAA), and co-polymers of acrylic acid.

Consumer awareness is increasingly shifting toward products which are sustainable and which provide a positive environmental profile, for example by comprising cleaning actives which are bio-based and/or biodegradable. Many conventional polymers used in detergent formulations, in particular polymers based on acrylic chemistry, are neither biodegradable nor bio-based and are, therefore, associated with detergent products providing a poor environmental performance profile. For example, polyacrylate homo- and co-polymers have been used in detergents for many years but are known to accumulate in an aquatic environment and, therefore, pose significant environmental harm.

Removing such polymers from detergent compositions would inevitably lead to a significant reduction in the cleaning performance of the detergent formulation, in particular in respect of preventing or reducing limescale formation.

Moreover, it is known that polycarboxylates are associated with the sequestering of calcium ions which are integral to the formation of limescale. However, known polycarboxylates used in detergent formulations often do not effectively maintain the solubility of formed calcium-adducts, therefore, the formed adducts can readily sediment upon the articles treated by the detergent formulation and affect the shine performance of the detergent formulation.

Further, some known polymers used in conventional, anti-scalant detergent formulations, which aim to provide an improved environmental performance profile, are typically synthesised by synthetic radical polymerization grafting techniques. Disadvantageously, polymers created by synthetic radical polymerization grafting techniques comprise a section of the polymer backbone that contains only carbon-carbon bonds. Consequently, such polymers are not readily biodegradable when used in a grafting density and with grafted chain lengths sufficient for use as an anti-scalant in a detergent formulation. Further, such grafting techniques are unreliable and often result in contamination with purely synthetic polymers (for example synthetic acrylic polymers) which are typically not readily biodegradable.

It is, therefore, an aim of embodiments of the present invention to provide an alternative to known, environmentally harmful polymers, which provides an improved cleaning performance, in particular in respect of preventing or reducing limescale formation, whilst providing sustainability and environmental benefits.

### SUMMARY OF THE INVENTION

According to a first aspect of the invention, there is provided a polysaccharide for a detergent formulation, wherein the polysaccharide comprises a polysaccharide backbone functionalised with carboxylic acid groups or salts or esters thereof, and sulfur-containing groups or salts or esters thereof.

Providing a polysaccharide comprising a polysaccharide backbone functionalised with carboxylic acid groups, or salts or esters thereof, and sulfur-containing groups, or salts or esters thereof, advantageously prevents, or at least significantly reduces, limescale formation when used in, for example, a dishwasher detergent formulation, in particular an automatic dishwasher. The inventive polysaccharide can be used either as an additional ingredient in state of the art dishwasher detergents, additives or rinse aid, or used as a separate product or can be also applied once or more often in any step of the dishwashing washing cycle, e.g. the inventive polysaccharide may be dosed in the pre-wash stage followed by addition of a state of the art detergent formulation in the main wash cycle. The polysaccharide of the invention may also be released continuously during one or more stages of a dishwashing cycle, for example, as a steady release from a slow dissolving source or from a gadget arranged to dose the inventive polysaccharide continuously or at defined time intervals during one or more dishwashing cycle stages.

The polysaccharide according to the invention advantageously provides a polymer which is not based on acrylic chemistry and, therefore, exhibits a superior environmental performance profile compared to conventional polymers used in known detergent formulations.

Moreover, polysaccharides are sustainable, bio-based and often readily biodegradable which further improves the superior environmental performance profile of the polysaccharide of the invention compared to conventional polymers used in known detergent formulations.

The polysaccharide according to the invention exhibits effective sequestering of multivalent cations, such as magnesium and calcium cations. As such, when the polysaccharide of the invention is used in, for example, dishwashing applications, the polysaccharide sequesters cations in the washing liquor and prevents the cations from depositing as salts, such as carbonate (e.g. limescale), phosphonate and silicate salts on the articles being washed. It is believed that the polysaccharide of the invention exhibits effective sequestering of multivalent cations due to the presence of the carboxylic acid groups, or salts or esters thereof. As such, advantageously, the polysaccharide of the invention prevents, or at least significantly reduces, the formation of limescale, in particular in hard-water, alkaline conditions, such as may be found in automatic dishwashers.

Surprisingly, it has been found that the polysaccharide of the invention significantly improves the solubility of adducts formed by the sequestering of multivalent cations, such as calcium ions. This considerably reduces the rate of sedimentation of the adducts upon articles being treated within, for example, a dishwasher, and keeps the adducts dispersed within the wash liquor. By providing a polysaccharide comprising a polysaccharide backbone functionalised with carboxylic acid groups, or salts or esters thereof, and sulfur-containing groups, or salts or esters thereof, there is a significant reduction in limescale formation and in discolouration and shine loss of articles, for example kitchenware, treated using, for example, a dishwashing detergent formulation comprising the polysaccharide of the invention.

It is believed that the improved solubility of adducts formed by the sequestering of calcium ions is due to the combination of the carboxylic acid groups, or its salts or its esters, functionality with the sulfur-containing groups, or its salts or its esters, functionality of the polysaccharide according to the invention.

It is believed that the efficacy of the carboxylic acid groups, or salts or esters thereof, to sequester calcium ions and therefore prevent, or significantly reduce, the formation of limescale, is greater when there is a higher density of functional groups bonded to the polysaccharide backbone. As such, the sulfur-containing groups, or salts or esters thereof, provides simultaneous advantages of significantly improving the solubility of adducts formed by the sequestering of calcium ions, and increasing the efficacy of the carboxylic groups, or salts or esters thereof, to sequester calcium ions by increasing the density of functional groups on the polysaccharide backbone.

The polysaccharide may be used in any stage of a dishwashing cycle of an automatic dishwasher. In this specification the term “dishwashing cycle” means the entire dishwashing operation, including a main wash and a rinse stage, a pre-wash, an intermediate stage, and any additional cleaning or rinsing stages.

The polysaccharide is not limited to automatic dishwashing applications and may find application in any industrial or domestic cleaning or treatment, including but not limited to, automatic dishwashing, hard surface cleaning, for example window cleaning and cleaning of an element made of glass, water treatment and laundry washing.

The polysaccharide may be any polysaccharide capable of functionalisation with a carboxylic acid group, or its salt or its ester, and a sulfur-containing group, or its salt or its ester.

The polysaccharide backbone may be selected from the group comprising, or derived from, maltodextrin, corn syrup, starch, cellulose, gum arabic, guar, xanthan, alginates, pectin, carrageenan, inulin and gellan. The starch may be any hydrolysed starch or hydrogenated starch hydrolysate formed by the hydrolysis of, for example, corn starch, potato starch or wheat starch.

Preferably, the polysaccharide backbone is maltodextrin, hydrolysed starch or starch.

Maltodextrins are polymers having D-glucose units linked, typically, by (alpha)-1,4 glycosidic bonds and having a dextrose equivalent (‘DE’) of less than or equal to about 20, typically between 3 and 20. Maltodextrin may include mixtures of monomers, dimers, oligomers and polymers of glucose. In embodiments comprising maltodextrin, the percentage composition of any mixtures of monomers, dimers, oligomers and polymers of glucose may depend upon the degree of hydrolysis, and is defined in terms of the DE.

Starch includes those derived from maize (corn) and conventional hybrids of maize, such as waxy maize and high amylose (i.e., greater than 40% amylose) maize, as well as other starches such as potato, tapioca, wheat, rice, pea, sago, oat, barley, rye, and amaranth, including conventional hybrids or genetically engineered materials. Further, starch may include hemicellulose or plant cell wall polysaccharides such as D-xylans. Examples of plant cell wall polysaccharides include arabino-xylans such as corn fibre gum, a component of corn fibre.

Advantageously, polysaccharide backbones selected from the group comprising, or derived from, maltodextrin, corn syrup, starch, cellulose, gum arabic, guar, xanthan, alginates, pectin, carrageenan, inulin and gellan, are biodegradable and, therefore, contribute to the superior environmental performance profile of the invention.

The polysaccharide backbone may have the formula:

P—O¹—
wherein P is the polysaccharide backbone and O¹ is an oxygen atom of a hydroxyl group on the native polysaccharide backbone (i.e., the polysaccharide before functionalisation with the carboxylic acid groups and sulfur-containing groups).

The carboxylic acid groups, or salts thereof, may have the formula:

—R—C(O)OH or —R—C(O)O—X+
wherein X is a cation, R is selected from an alkyl group, an ammonium group, an aryl group, a heteroaryl group, a cycloalkyl group, a heterocycloalkyl group, an alkoxy group, an aryloxy group and an alcohol group.
X may be selected from the group comprising sodium, potassium, and ammonium.

The alkyl group may be any C1 to C20, C1 to C10, C1 to C5, or C1 to C3, linear or branched alkyl group. Examples of suitable alkyl groups include, but are not limited to, methyl, ethyl, n-propyl, isopropyl, n-butyl, isobutyl, sec-butyl, tert-butyl, tert-amyl, pentyl, hexyl, heptyl and octyl. The alkyl group may be a substituted alkyl group.

The ammonia group may be any primary, secondary, tertiary or quaternary ammonia or ammonium group. The quaternary ammonium group may be selected from alkylammonium, dialkylammonium, trialkylammonium, iminium, amidinium, formamidinium, guanidinium and biguanidinium quaternary ammonium groups. The ammonia group or ammonium group may be substituted with any alkyl group, aryl group, heteroaryl group, cycloalkyl group, heterocycloalkyl group, alkoxy group, aryloxy group and alcohol group described herein.

The aryl group may comprise 5, 6, 7, 8, 9 or more carbon atoms. The aryl group may be substituted. Examples of aryl groups include, but are not limited to, 3-methylphenyl, 4-methylphenyl and dimethylphenyl.

The heteroaryl group may comprise 4, 5, 6, 7, 8, 9, or more than 9 atoms. The heteroaryl group may be substituted. Examples of heteroaryl groups include, but are not limited to, aromatic C3-C8 heterocyclic groups comprising one oxygen or sulfur atom or up to four nitrogen atoms, or a combination of one oxygen or sulfur atom and up to two nitrogen atoms, and their substituted as well as benzo- and pyrido-fused derivatives, for example, connected via one of the ring-forming carbon atoms. The heteroaryl group may be substituted with one or more substituents, independently selected from halo, hydroxy, amino, cyano, nitro, alkylamido, acyl, C1-C6-alkoxy, C1-C6-alkyl, C1-C6-hydroxyalkyl, C₁-C6-aminoallcyl, alkylsulfenyl, alkylsulfinyl, alkylsulfonyl, sulfamoyl, or trifluoromethyl. Examples of heteroaryl groups include, but are not limited to, unsubstituted and mono- or di-substituted derivatives of furan, benzofuran, thiophene, benzothiophene, pyrrole, pyridine, pyrazole, pyrylium, imidazole, indole, oxazole, benzoxazole, isoxazole, benzisoxazole, thiazole, benzothiazole, isothiazole, imidazole, benzimidazole, pyrazole, indazole, tetrazole, quinoline, isoquinoline, pyridazine, pyrimidine, purine and pyrazine, 1,2,4-triazine, 1,3,5-triazine, furazan, 1,2,3-oxadiazole, 1,2,5-oxadiazole, 1,2,3-thiadiazole, 1,2,4-thiadiazole, 1,2,5-thiadiazole, 1,3,4-thiadiazole, thiophene, triazole, benzotriazole, pteridine, phenoxazole, oxadiazole, benzopyrazole, quinolizine, cinnoline, phthalazine, quinazoline, and quinoxaline.

The cycloalkyl group may be any C3 to C20, preferably C3 to C10, cycloalkyl group. The cycloalkyl group may be substituted. Examples of cycloalkyl groups include, but are not limited to, cyclopropane, cyclobutane, cyclopentane and cyclohexane.

The heterocycloalkyl group may comprise 4, 5, 6, 7, 8, 9, or more than 9 atoms. The heterocycloalkyl group may be substituted. Examples of heterocycloalkyl group include, but are not limited to, C3-C8 heterocyclic groups comprising one, two, three or more oxygen or sulfur atoms or up to four nitrogen atoms, or a combination of one, two, three or more oxygen or sulfur atoms and up to two nitrogen atoms, and their substituted as well as fused derivatives, for example, connected via one of the ring-forming carbon atoms. The heterocycloalkyl group may be substituted with one or more substituents, independently selected from halo, hydroxy, amino, cyano, nitro, alkylamido, acyl, C1-C6-alkoxy, C1-C6-alkyl, C1-C6-hydroxyalkyl, C1-C6-aminoallcyl, alkylsulfenyl, alkylsulfinyl, alkylsulfonyl, sulfamoyl, or trifluoromethyl. Examples of heterocycloalkyl groups include, but are not limited to, unsubstituted and mono- or di-substituted derivatives of pyrrolidine, pyrroline, pyrazolidine, imidazolidine, pyrazoline, imidazoline, tetrahydrofuran, 1,3-dioxolane, tetrahydrothiophene, 1,2-oxathiolane, 1,3-oxathiolane, sulfolane, 2,4-thiazolidinedione, succinimide, 2-oxazolidone, hydantoin, piperidine, piperazine, tetrahydropyran, 2H-pyran, 4H-pyran, 1,4-dioxane, 1,4-dioxine, thiane, 2H-thiopyran, 4H-thiopyran, 1,3-dithiane, 1,4-dithiane, 1,3,5-trithiane, morpholine, 4H-1,2-oxazine, 2H-1,2-oxazine, 6H-1,2-oxazine, 4H-1,3-oxazine, 2H-1,3-oxazine, 6H-1,3-oxazine, 4H-1,4-oxazine, 2H-1,4-oxazine, thiomorpholine, thiazine, 4H-1,4-thiazine, 2H-1,2-thiazine, 6H-1,2-thiazine, 2H-1,4-thiazine, cytosine, thymine, uracil, and thiomorpholine dioxide.

The alkoxy group may be any C1 to C10 alkoxy group, for example a methoxy or ethoxy group. The alkoxy group may be substituted.

The aryloxy group may comprise 5, 6, 7, 8, 9 or more carbon atoms. The aryloxy group may be substituted. The aryloxy group may be a phenoxy group. The alcohol group may comprise any C1 to C20, preferably C1 to C10, more preferably C1 to C6 alcohol. The alcohol group may be substituted. The alcohol group may be any primary, secondary or tertiary alcohol group. The alcohol group may be any linear or branched alcohol group. The alcohol group may comprise more than one hydroxyl group, for example, two hydroxyl groups (diol) or three hydroxyl groups (triol).

The carboxylic acid groups, or salts thereof, may be bonded to a hydroxyl group of the polysaccharide. As such, the carboxylic acid group (or salt thereof)-functionalised polysaccharide backbone portions may have the formula:

P—O¹—R—C(O)OH or P—O¹—R—C(O)O⁻X⁺

In a preferred embodiment, the R group is a methyl group and, therefore, the carboxylic acid groups, or salts thereof, may have the formula:

—CH₂—C(O)OH or —CH₂—C(O)O⁻X⁺

In this embodiment, the carboxylic acid group (or salt thereof)-functionalised polysaccharide backbone portions may have the formula:

P—O¹—CH₂—C(O)OH or P—O¹—CH₂—C(O)O⁻X⁺

In embodiments where the R group is a CH₂ group and, therefore, the carboxylic acid groups, or salts thereof, have the above formula, the polysaccharide of the invention may be synthesised using chloroacetic acid. Beneficially, chloro-alkyl-carboxylic acids, in particular chloroacetic acid, are readily available organic acids and have established synthetic pathways in organic synthesis.

It has been found that the R group has minimal chemical function other than to link the carboxylic acid group to the polysaccharide backbone, via an oxygen atom, herein defined as O¹, of a hydroxyl group. As such, preferably, the R group may be a short chain alkyl group, such as a C1 to C3 group, in particular a CH₂ group. While longer alkyl chain groups, or any R group as described above, may be used, it has been found that R groups comprising a longer chain alkyl group (for example a C5 to C20 group) or complex organic groups (for example heteroaryl or cycloalkyl groups) may lead to ballast and may increase the required dosage of the carboxylic acid groups, or salts or esters thereof, in the synthesis of the polysaccharide.

The carboxylic acid groups, or salts or esters thereof, may be derived from any halogen-substituted analogue, for example a chlorinated analogue, of a carboxylic acid or dicarboxylic acid. Such carboxylic acids may include, but are not limited to, chloroacetic acid, 3-chloropropanoic acid, 2-chloropropanoic acid, 4-chlorobutanoic acid, 3-chlorobutanoic acid, 2-chlorobutanoic acid, 5-chloropentanoic acid, 4-chloropentanoic acid, 3-chloropentanoic acid, or 2-chloropentanoic acid.

The carboxylic acid groups, or salts or esters thereof, may be derived from any monoethylenically unsaturated C3-C10 carboxylic acid. Examples of such carboxylic acids include, but are not limited to, acrylic acid, methacrylic acid, ethacrylic acid, [alpha]-chloro-acrylic acid, [alpha]-cyano acrylic acid, [beta]-methyl-acrylic acid (crotonic acid), [alpha]-phenyl acrylic acid, [beta]-acryloxy propionic acid, sorbic acid, [alpha]-chloro sorbic acid, angelic acid, cinnamic acid, p-chloro cinnamic acid, and [beta]-styryl acrylic acid (1-carboxy-4-phenyl butadiene-1,3). In some embodiments, the alkali, alkaline earth metal or ammonium salts of these acids may be used.

The carboxylic acid groups, or salts or esters thereof, may be derived from any dicarboxylic acid. Examples of such dicarboxylic acids include, but are not limited to, monoethylenically unsaturated C4-C10 dicarboxylic acids, the alkali or alkaline earth metal or ammonium salts thereof, and the anhydrides thereof. Examples of such dicarboxylic acids include, but are not limited to, itaconic acid, maleic acid, citraconic acid, mesaconic acid, glutaconic acid, aconitic acid, fumaric acid, and tricarboxy ethylene. Moieties such as maleic anhydride or acrylamide that can be derivatised to an acid-containing group may also be used. The alkali, alkaline earth metal or ammonium salts of these acids may also be used.

In some embodiments, the carboxylic acid groups may comprise carboxylic ester (i.e., carboxylate ester) groups having the formula:

—R—C(O)OR¹
wherein R is independently as defined hereinabove and R¹ is an alkyl group.

The alkyl group of R¹ may be any C1 to C20, C1 to C10, C1 to C5, or C1 to C3, linear or branched alkyl group. Examples of suitable alkyl groups include, but are not limited to, methyl, ethyl, n-propyl, isopropyl, n-butyl, isobutyl, sec-butyl, tert-butyl, tert-amyl, pentyl, hexyl, heptyl and octyl. The alkyl group may be a substituted alkyl group.

As such, the carboxylic ester group-functionalised polysaccharide backbone portions may have the formula:

P—O¹—R—C(O)OR¹
wherein P, O¹, R and R¹ are independently as defined hereinabove.

The carboxylic acid groups, or salts or esters thereof, may be bonded to a hydroxyl group of the polysaccharide by etherification. The etherification reaction is preferably carried out by the simultaneous addition of reagents transferring carboxylic acid groups, or salts or esters thereof, and reagents transferring sulfur-containing groups, or salts or esters thereof. In embodiments comprising the carboxylic acid groups, or salts or esters thereof, bonded to a hydroxyl group of the polysaccharide by etherification, the polysaccharide backbone comprises an ether-linkage to an R group of the carboxylic acid groups, or salts or esters thereof. The polysaccharide may have an average molecular weight of between 1 and 50 kDa, preferably between 10 and 25 kDa, before functionalisation with the carboxylic acid groups, or salts or esters thereof, and the sulfur-containing groups, or salts or esters thereof.

Surprisingly, it has been found that a polysaccharide having an average molecular weight of between 1 and 50 kDa before functionalisation provides an optimum molecular weight for application as a limescale dispersant because polymers having an average molecular weight below 1 kDa do not possess the surface active capability to act as limescale dispersants, and polymers having an average molecular weight above 50 kDa decrease the efficacy of the polymer to act as a limescale dispersant; it is believed via a flocculation mechanism bridging between particles promoting formation of aggregates that scatter light more efficiently.

The carboxylic acid groups, or salts or esters thereof, and the sulfur-containing groups, or salts or esters thereof, may be present in a molar ratio of between about 4:1 and about 1:2.

Advantageously, a polysaccharide functionalised with carboxylic acid groups, or salts or esters thereof, and sulfur-containing groups, or salts or esters thereof, in a molar ratio of between about 4:1 and about 1:2, provides an optimum efficacy in terms of preventing, or at least significantly reducing, limescale formation, for example when the polysaccharide is used as an ingredient in a dishwashing detergent formulation. Further advantageously, a more favourable cleaning performance, in particular in respect of reducing shine loss, is provided when the carboxylic acid groups, or salts or esters thereof, and the sulfur-containing groups, or salts or esters thereof, are present in a molar ratio of between about 4:1 and about 1:2, compared to polysaccharides comprising these groups in a molar ratio not encompassed by the range of between about 4:1 and about 1:2.

The carboxylic acid groups, or salts or esters thereof, and the sulfur-containing groups, or salts or esters thereof, may be present in a molar ratio of between about 4:1 and about 1:2, between about 4:1 and about 1:1.5, between about 4:1 and about 1:1, between about 4:1 and about 1.5:1, or between about 4:1 and about 2:1.

The carboxylic acid groups, or salts or esters thereof, and the sulfur-containing groups, or salts or esters thereof, may be present in a molar ratio of about 4:1, about 3.5:1, about 3:1, about 2.5:1, about 2:1, about 1.5:1, about 1:1, about 1:1.5, or about 1:2.

The sulfur-containing groups each preferably comprise a sulfonate or sulfonate-containing group, or salt or ester thereof.

The sulfur-containing groups, or salts thereof, may have the formula:

—R—SO₃⁻X⁺ or —SO₃⁻X⁺
wherein R is selected from a hydrogen atom, an alkyl group, an ammonia group, an aryl group, a heteroaryl group, a cycloalkyl group, a heterocycloalkyl group, an alkoxy group, an aryloxy group and an alcohol group, and X is a cation.
X may be any monovalent metal, for example sodium or potassium, or may be ammonium, or hydrogen for example.

The alkyl group may be any C1 to C20, C1 to C10, C1 to C5, or C1 to C3, linear or branched alkyl group. Examples of suitable alkyl groups include, but are not limited to, methyl, ethyl, n-propyl, isopropyl, n-butyl, isobutyl, sec-butyl, tert-butyl, tert-amyl, pentyl, hexyl, heptyl and octyl. The alkyl group may be a substituted alkyl group.

The ammonia group may be any primary, secondary, tertiary or quaternary ammonia or ammonium group. The quaternary ammonium group may be selected from alkylammonium, dialkylammonium, trialkylammonium, iminium, amidinium, formamidinium, guanidinium and biguanidinium quaternary ammonium groups. The ammonia group or ammonium group may be substituted with any alkyl group, aryl group, heteroaryl group, cycloalkyl group, heterocycloalkyl group, alkoxy group, aryloxy group and alcohol group described herein.

The aryl group may comprise 5, 6, 7, 8, 9 or more carbon atoms. The aryl group may be substituted. Examples of aryl groups include, but are not limited to, 3-methylphenyl, 4-methylphenyl and dimethylphenyl. 20 The heteroaryl group may comprise 4, 5, 6, 7, 8, 9, or more than 9 atoms. The heteroaryl group may be substituted. Examples of heteroaryl groups include, but are not limited to, aromatic C3-C8 heterocyclic groups comprising one oxygen or sulfur atom or up to four nitrogen atoms, or a combination of one oxygen or sulfur atom and up to two nitrogen atoms, and their substituted as well as benzo- and pyrido-fused derivatives, for example, connected via one of the ring-forming carbon atoms. The heteroaryl group may be substituted with one or more substituents, independently selected from halo, hydroxy, amino, cyano, nitro, alkylamido, acyl, C1-C6-alkoxy, C1-C6-alkyl, C1-C6-hydroxyalkyl, C1-C6-aminoallcyl, alkylsulfenyl, alkylsulfinyl, alkylsulfonyl, sulfamoyl, or trifluoromethyl. Examples of heteroaryl groups include, but are not limited to, unsubstituted and mono- or di-substituted derivatives of furan, benzofuran, thiophene, benzothiophene, pyrrole, pyridine, pyrazole, pyrylium, imidazole, indole, oxazole, benzoxazole, isoxazole, benzisoxazole, thiazole, benzothiazole, isothiazole, imidazole, benzimidazole, pyrazole, indazole, tetrazole, quinoline, isoquinoline, pyridazine, pyrimidine, purine and pyrazine, 1,2,4-triazine, 1,3,5-triazine, furazan, 1,2,3-oxadiazole, 1,2,5-oxadiazole, 1,2,3-thiadiazole, 1,2,4-thiadiazole, 1,2,5-thiadiazole, 1,3,4-thiadiazole, thiophene, triazole, benzotriazole, pteridine, phenoxazole, oxadiazole, benzopyrazole, quinolizine, cinnoline, phthalazine, quinazoline, and quinoxaline.

The cycloalkyl group may be any C3 to C20, preferably C3 to C10, cycloalkyl group. The cycloalkyl group may be substituted. Examples of cycloalkyl groups include, but are not limited to, cyclopropane, cyclobutane, cyclopentane and cyclohexane.

The heterocycloalkyl group may comprise 4, 5, 6, 7, 8, 9, or more than 9 atoms. The heterocycloalkyl group may be substituted. Examples of heterocycloalkyl group include, but are not limited to, C3-C8 heterocyclic groups comprising one, two, three or more oxygen or sulfur atoms or up to four nitrogen atoms, or a combination of one, two, three or more oxygen or sulfur atoms and up to two nitrogen atoms, and their substituted as well as fused derivatives, for example, connected via one of the ring-forming carbon atoms. The heterocycloalkyl group may be substituted with one or more substituents, independently selected from halo, hydroxy, amino, cyano, nitro, alkylamido, acyl, C1-C6-alkoxy, C1-C6-alkyl, C1-C6-hydroxyalkyl, C1-C6-aminoallcyl, alkylsulfenyl, alkylsulfinyl, alkylsulfonyl, sulfamoyl, or trifluoromethyl. Examples of heterocycloalkyl groups include, but are not limited to, unsubstituted and mono- or di-substituted derivatives of pyrrolidine, pyrroline, pyrazolidine, imidazolidine, pyrazoline, imidazoline, tetrahydrofuran, 1,3-dioxolane, tetrahydrothiophene, 1,2-oxathiolane, 1,3-oxathiolane, sulfolane, 2,4-thiazolidinedione, succinimide, 2-oxazolidone, hydantoin, piperidine, piperazine, tetrahydropyran, 2H-pyran, 4H-pyran, 1,4-dioxane, 1,4-dioxine, thiane, 2H-thiopyran, 4H-thiopyran, 1,3-dithiane, 1,4-dithiane, 1,3,5-trithiane, morpholine, 4H-1,2-oxazine, 2H-1,2-oxazine, 6H-1,2-oxazine, 4H-1,3-oxazine, 2H-1,3-oxazine, 6H-1,3-oxazine, 4H-1,4-oxazine, 2H-1,4-oxazine, thiomorpholine, thiazine, 4H-1,4-thiazine, 2H-1,2-thiazine, 6H-1,2-thiazine, 2H-1,4-thiazine, cytosine, thymine, uracil, and thiomorpholine dioxide.

The alkoxy group may be any C1 to C10 alkoxy group, for example a methoxy or ethoxy group. The alkoxy group may be substituted.

The aryloxy group may comprise 5, 6, 7, 8, 9 or more carbon atoms. The aryloxy group may be substituted. The aryloxy group may be a phenoxy group.

The alcohol group may comprise any C1 to C20, preferably C1 to C10, more preferably C1 to C6 alcohol. The alcohol group may be substituted. The alcohol group may be any primary, secondary or tertiary alcohol group. The alcohol group may be any linear or branched alcohol group. The alcohol group may comprise more than one hydroxyl group, for example, two hydroxyl groups (diol) or three hydroxyl groups (triol).

The sulfur-containing groups, or salts thereof, may be bonded to a hydroxyl group of the polysaccharide. As such, the sulfur-containing group (or salt thereof)-functionalised polysaccharide backbone portions may have the formula:

P—O¹—R—SO₃⁻X⁺or P—O¹—SO₃⁻X⁺
wherein, R and X are independently as defined hereinabove, and P is the polysaccharide backbone and O¹ is an oxygen atom formed from a hydroxyl group on the native polysaccharide backbone, P.

In a preferred embodiment, the R group is an ethyl group (Et) and, therefore, the sulfur-containing groups, or salts thereof, may be sulfoethyl groups having the formula:

-Et-SO₃⁻X⁺

In this embodiment, the sulfoethyl group-functionalised polysaccharide backbone portions may have the formula:

P—O¹-Et-SO₃⁻X⁺

In embodiments comprising sulfur-containing group salts, the salts preferably comprise a sulfoethyl group and sodium, having the formula:

-Et-SO₃Na

In this embodiment, the sulfoethyl group sodium salt-functionalised polysaccharide backbone may have the formula:

P—O¹-Et-SO₃Na

In some embodiments, the sulfur-containing groups may comprise sulfur-containing ester groups having the formula:

—R—SO₃R¹
wherein R is independently as defined hereinabove and R¹ is an alkyl group.

The alkyl group of R¹ may be any C1 to C20, C1 to C10, C1 to C5, or C1 to C3, linear or branched alkyl group. Examples of suitable alkyl groups include, but are not limited to, methyl, ethyl, n-propyl, isopropyl, n-butyl, isobutyl, sec-butyl, tert-butyl, tert-amyl, pentyl, hexyl, heptyl and octyl. The alkyl group may be a substituted alkyl group.

As such, the sulfur-containing ester group-functionalised polysaccharide backbone portions may have the formula:

P—O¹—R—SO₃R¹
wherein P, O¹, R and R¹ are independently as defined hereinabove.

It has been found that the R group has minimal chemical function other than to link the sulfur-containing group, or salt or ester thereof, to the polysaccharide backbone, via an oxygen atom, herein defined as O¹, of a hydroxyl group. As such, preferably, the R group may be a short chain alkyl group, such as a C1 to C3 group, in particular an ethyl (C₂H₄) group. While longer alkyl chain groups, or any group as described above, may be used, it has been found that R groups comprising a longer chain alkyl group (for example a C5 to C20 group) or complex organic groups (for example heteroaryl or cycloalkyl groups) may lead to ballast and may increase the required dosage of the sulfur-containing group, or salt or ester thereof, in the synthesis of the polysaccharide.

The sulfur-containing groups, or salts or esters thereof, may be bonded to a hydroxyl group of the polysaccharide by etherification. The sulfur-containing groups, or salts or esters thereof, may be bonded to a hydroxyl group of the polysaccharide and the oxygen atom of the hydroxyl group and the sulfur atom of the sulfur-containing groups, or salts or esters thereof, may be bridged by a spacer moiety. The spacer moiety may be any C1 to C5 linear or branched alkyl chain, preferably any C1 to a C3 linear alkyl chain, such as an ethyl spacer, i.e. a —CH₂CH₂-group. The spacer moiety may be instead of, or in addition to, an R group.

The polysaccharide may therefore comprise a polysaccharide backbone, comprising the general formula P, comprising carboxylic acid groups, or salts or esters thereof, of the formula —Y—C(O)OZ and sulfur-containing groups, or salts or esters thereof, of formula —Y—SO₃Z, each carboxylic acid group salt or ester thereof and each sulfur-containing group, salt or ester thereof bonded via an ether linkage to the backbone P via an oxygen atom formed from hydroxyl groups on the polysaccharide, wherein
Y is R or is absent,
Z is R₁, H or X,
R and R¹ are as defined hereinabove,
X is a cation as defined hereinabove.

In this embodiment, the carboxylic acid group (or salt or ester thereof)-functionalised polysaccharide backbone portions may have the formula:

P—O¹—Y—C(O)OZ
and the sulfur-containing group (or salt or ester thereof)-functionalised polysaccharide backbone portions may have the formula:

P—O¹—Y—SO₃Z

In some embodiments, the carboxylic acid groups, or salts or esters thereof, are carboxyalkyl groups, and the sulfur-containing groups, or salts or esters thereof, comprise a sulfonate group. In some embodiments the polysaccharide backbone may be a maltodextrin, the carboxylic acid groups, or salts or esters thereof, are carboxyalkyl groups, and the sulfur-containing groups, or salts or esters thereof, comprise a sulfonate group.

In preferred embodiments, the carboxylic acid groups, or salts or esters thereof, are carboxymethyl groups, and the sulfur-containing groups, or salts or esters thereof, are sulfoethyl groups.

In a further preferred embodiment, the polysaccharide backbone is maltodextrin and the carboxylic acid groups, or salts or esters thereof, are carboxymethyl groups, and the sulfur-containing groups, or salts or esters thereof, are sulfoethyl groups. In such an embodiment, the functionalised polysaccharide backbone according to the invention is carboxymethylsulfoethyl maltodextrin.

The polysaccharide backbone may be further chemically modified, in addition to functionalisation with the carboxylic acid groups, or salts or esters thereof, and the sulfur-containing groups, or salts or esters thereof. Chemically modified derivatives may include phosphates, phosphonates, aldehydes, silanes, alkyl glycosides, alkyl-hydroxyalkyls, carboxy-alkyl ethers and other derivatives, or additional carboxylate or sulfonate groups. The polysaccharide backbone may be chemically modified before, during or after functionalisation with the carboxylic acid groups, or salts or esters thereof, and the sulfur-containing groups, or salts or esters thereof.

The polysaccharide backbone may be chemically modified or derivatised by etherification (for example, via treatment with propylene oxide, ethylene oxide, 2,3-epoxypropyl trimethyl ammonium chloride), esterification (for example, via reaction with acetic anhydride, octenyl succinic anhydride (‘OSA’)), acid hydrolysis, dextrinization, oxidation or enzyme treatment (for example, starch modified with [alpha]-amylase, [beta]-amylase, pullanase, isoamylase or glucoamylase), or various combinations of these treatments. These treatments may be performed before, during or after functionalisation with the carboxylic acid groups, or salts or esters thereof, and the sulfur-containing groups, or salts or esters thereof.

The polysaccharide may comprise a highly functionalised polysaccharide backbone. ‘Highly functionalised’ means a polysaccharide backbone which may have an average total degree of functionalisation of at least about 2.4, at least about 2.6, at least about 2.7, or at least about 2.8.

The degree of functionalisation of the polysaccharide backbone with the sulfur-containing groups, or salts or esters thereof, may be less than about 1.0, about 0.8, about 0.6, or less than about 0.4.

The polysaccharide backbone may have a total degree of functionalisation of at least about 1.0, at least about 1.4, at least about 1.6, at least about 1.8, at least about 2.0, at least about 2.2, at least about 2.4, at least about 2.6, at least about 2.7, or at least about 2.8.

The polysaccharide backbone may have a total degree of functionalisation of no more than about 3.4, about 3.2, about 3.0, about 2.8, about 2.6, about 2.4, about 2.2, about 2.1, about 2.0, about 1.9, about 1.8, about 1.7, about 1.6, about 1.5, about 1.4, about 1.3, or no more than about 1.2.

The polysaccharide backbone may have a total degree of functionalisation of between about 1.0 and about 3.4, between about 1.2 and about 3.3, between about 1.4 and about 3.2, between about 1.6 and about 3.1, between about 1.8 and about 3.0, between about 2.0 and about 3.0, between about 2.2 and about 2.9, between about 2.4 and about 2.8, between about 2.5 and about 2.8, between about 2.6 and about 2.8, or about 2.7.

The degree of functionalisation of the polysaccharide backbone with carboxylic acid groups, or salts or esters thereof, is determined by method B of ASTM-D 1439-83 a, method B. The degree of functionalisation of the polysaccharide backbone with sulfur-containing groups, or salts or esters thereof, is determined by Ehrenberger/Gorbach titration with barium perchlorate against thorine (Ehrenberger/Gorbach: Methoden der organischen Elementar-und Spurenanalyse, Verlag Chemie, Weinheim, 1973, page 223). The necessary digestion is carried out by the Schoninger method (Heraeus Manual EW-F 1.6.1. [method 1]).

Degrees of functionalisation of up to about 1.0 are generally obtained in single-stage etherification processes (see, for example, K. Engelskirchen in: Houben-Weyl “Makromolekulare Stoffe”, Vol. E 20/III, page 2074, edited by A. Barth and J. Falbe, Georg-Thieme-Verlag, Stuttgart/New York, 1987).

A process for the synthesis of a polysaccharide according to the invention comprises:
a. Reaction of reagents transferring sulfur-containing groups, or salts or esters thereof, and/or carboxylic acid groups, or salts or esters thereof, with an alkali polysaccharide by a slurry process to a total degree of substitution of approx. 0.7 to approx. 0.95. The etherification reagents may be reacted together, or may be reacted one after the other. Preferably, the reaction initially takes place with reagents transferring sulfur-containing groups, or salts or esters thereof, the reagent being added to the slurry medium in particular before the alkali polysaccharide,
b. The quantity of slurry medium is optionally reduced and the functionalised polysaccharide prepared in step (a) is further etherified in a second reaction step carried out without preliminary purification or preliminary grinding by addition of more etherification reagents to total degrees of functionalisation of >2.0, preferably >2.4 and, more preferably, >2.6. The degree of substitution by sulfur-containing groups, or salts or esters thereof, may be <0.6 and, more particularly, <0.4,
c. Separation, optionally complete or partial removal of secondary reaction products by purification with preferably aqueous/organic solvents, followed by drying, grinding and making up of the resulting functionalised polysaccharide derivative using conventional techniques.

According to a second aspect of the invention there is provided a detergent formulation for an automatic dishwashing cycle, the detergent formulation comprising the polysaccharide according to the first aspect of the invention.

By the term ‘detergent formulation’, it is meant a formulation comprising one or more cleaning actives suitable for a dishwashing cycle, in addition to the polysaccharide according to the first aspect of the invention. A detergent formulation may comprise at least one cleaning active selected from the group comprising a builder, co-builder, surfactant, alkalinity source, acidity source, enzyme, further polymer, anti-corrosion agent, bleaching agent or system, perfume, colourant or care agent, or a mixture thereof.

The detergent formulation may be in the form of a solid detergent formulation, liquid detergent formulation or gel detergent formulation.

By the term ‘solid detergent formulation’, it is meant a detergent formulation in solid form, including, for example, a powdered solid, a tablet, a coated granule or a co-granule. The powdered solid may be a compressed powder or a non-compressed powder, or a mixture thereof.

Gels are generally defined as a non-fluid colloidal network or polymer network that is expanded throughout its whole volume by a fluid, with hydrogels having water as the expanding or swelling agent. Herein, the term gel is not limited to a strictly colloidal composition and for the purposes of the invention the term gel may comprise a gel-like thickened liquid. The term ‘gel-like’ may refer to a combination of liquid and solid, or a suspension of solid-in-liquid, that has the appearance and/or consistency of a gel. A gel or gel-like material may have a viscosity at low shear rates (i.e. 0.1 s⁻¹) of greater than 3.5 Pa's at 25° C. and atmospheric pressure; for example as recorded on a research rheometer with a Brookfield V73 vane in a small concentric cylinder system.

The detergent formulation in the form of a gel may comprise a suspension of a powder or granules. The powder or granules may comprise one or more cleaning actives.

The polysaccharide may be present in the detergent formulation in an amount of between about 0.1 and about 10.0 wt. %, between about 0.5 and about 9.5 wt. %, between about 1.0 and about 9.0 wt. %, between about 1.5 and about 8.5 wt. %, between about 2.0 and about 8.0 wt. %, between about 2.5 and about 7.5 wt. %, between about 3.0 and about 7.0 wt. %, between about 3.5 and about 6.5 wt. %, between about 4.0 and about 6.0 wt. %, between about 4.5 and about 5.5 wt. %, or about 5.0 wt. %, based on the total weight of the detergent formulation.

The polysaccharide may be present in the detergent formulation in an amount of between about 0.1 and about 5.0 wt. %.

The polysaccharide may be present in the detergent formulation in an amount of at least about 0.1 wt. %, about 0.5 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, or at least about 10.0 wt. %, based on the total weight of the detergent formulation.

The polysaccharide may be present in the detergent formulation in an amount of no more than about 0.1 wt. %, about 0.5 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, or no more than about 10.0 wt. %, based on the total weight of the detergent formulation.

The detergent formulation may further comprise at least one builder.

The at least one builder may be selected from the group containing hydroxycarboxylates, aminocarboxylates, dicarboxylic acid amines and/or phosphates, or the salts thereof, or mixtures thereof. The hydroxycarboxylates may be, for example, a citrate salt, for example trisodium citrate or citrate dihydrate, which may be anhydrous. The aminocarboxylate may be, for example, methyl glycine diacetic acid (MGDA), N,N-dicarboxymethyl glutamic acid (GLDA), or mixtures thereof. The dicarboxylic acid amine may be, for example, iminodisuccinic acid (IDS). The phosphate may be, for example, tripolyphosphate.

The at least one builder may be selected from the group containing aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), a-alanine-N,N-diacetic acid (a-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N, N-diacetic acid (ANDA), sulfanilic acid-N, N-diacetic acid (SLDA), taurine-N, N-diacetic acid (TUDA) and sulfomethyl-N, N-diacetic acid (SMDA) and (hydroxy)iminodisuccinic acid (HIDS) and alkali metal salts or ammonium salts thereof, or mixtures thereof.

The at least one builder may be present in a total amount of between about 10 and about 60 wt. %, between about 15 and about 55 wt. %, between about 20 and about 50 wt. %, between about 25 and about 45 wt. %, between about 30 and 40 wt. %, or about 35 wt. %, based on the total weight of the detergent formulation.

The at least one builder may be present in a total amount of about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, or about 60 wt. %, based on the total weight of the detergent formulation.

The at least one builder may be present in a total amount of at least about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, or at least about 60 wt. %, based on the total weight of the detergent formulation.

The at least one builder may be present in a total amount of no more than about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, or no more than about 60 wt. %, based on the total weight of the detergent formulation.

The detergent formulation may further comprise at least one bleaching system.

The at least one bleaching system may comprise one or more bleaching agents and/or one or more bleach activators and/or one or more bleach catalysts. The one or more bleaching agents may be selected from the group comprising a percarbonate, for example coated sodium percarbonate or uncoated sodium percarbonate. The one or more bleach activators may be tetraacetylethylenediamine (TAED). The one or more bleach catalyst may be a manganese complex comprising triazacyclononane (TACN), or any derivatives of a TACN ligand, for example 1,4,7-trimethyl-TACN, or manganese oxalate, manganese acetate or a dinuclear manganese complex, for example a dinuclear manganese complex comprising TACN or any derivatives of a TACN ligand, for example 1,4,7-trimethyl-TACN, or mixtures thereof.

The at least one bleaching system may be present in a total amount of between about 0.0 and about 30.0 wt. %, between about 2.5 and about 27.5 wt. %, between about 5.0 and about 25.0 wt. %, between about 7.5 and about 22.5 wt. %, between about 10.0 and about 20.0 wt. %, between about 12.5 and about 17.5 wt. %, or about 15.0 wt. %, based on the total weight of the detergent formulation.

The at least one bleaching system may be present in a total amount of at least about 1.0 wt. %, about 2.5 wt. %, about 5.0 wt. %, about 7.5 wt. %, about 10.0 wt. %, about 12.5 wt. %, about 15 wt. %, about 17.5 wt. %, about 20.0 wt. %, about 22.5 wt. %, about 25.0 wt. %, about 27.5 wt. %, or about 30 wt. %, based on the total weight of the detergent formulation.

The detergent formulation may be free, or at least substantially free, of any bleaching system.

The detergent formulation may further comprise at least one surfactant.

The at least one surfactant may be selected from the group comprising non-ionic, anionic, cationic, amphoteric or zwitterionic surface active agents, or suitable mixtures thereof. The non-ionic surfactant may be an ethoxylated non-ionic surfactant prepared by the reaction of a monohydroxy alkanol with about 6 to about 20 carbon atoms. The surfactant may have at least about 12 moles, at least about 16 moles, at least about 20 moles, or at least about 25 moles, of ethylene oxide per mole of alcohol. The non-ionic surfactant may be from a linear chain fatty alcohol with about 16 to about 20 carbon atoms and at least about 12 moles, at least about 16 moles, or at least about 20 moles of ethylene oxide per mole of alcohol.

The non-ionic surfactant may additionally comprise propylene oxide units in the surfactant molecule. The propylene oxide units may constitute up to about 25% by weight, up to about 20% by weight, or up to about 15% by weight of the overall molecular weight of the non-ionic surfactant.

The surfactant may be an ethoxylated mono-hydroxy alkanols which additionally comprise polyoxyethylene-polyoxypropylene block copolymer units. The alcohol portion of the ethoxylated mono-hydroxy alkanols may constitute more than about 30% by weight, more than about 50% by weight, or more than about 70% by weight of the overall molecular weight of the non-ionic surfactant. The non-ionic surfactant may comprise reverse block copolymers of polyoxyethylene and polyoxypropylene and block copolymers of polyoxyethylene and polyoxypropylene initiated with trimethylolpropane.

The non-ionic surfactant may be a surfactant described by the formula:

R¹O[CH₂CH(CH₃)O]x[CH₂CH₂O]Y[CH₂CH(OH)R²]

where R¹ represents a linear or branched chain aliphatic hydrocarbon group with about 4 to about 18 carbon atoms or a mixture thereof, R² represents a linear or branched chain aliphatic hydrocarbon rest with about 2 to about 26 carbon atoms or a mixture thereof, x is a value between about 0.5 and about 1.5, and y is a value of at least about 15.

The non-ionic surfactant may be an end-capped polyoxyalkylated non-ionic surfactant of the formula:

R¹O[CH₂CH(R₃)O]x[CH₂]kCH(OH)[CH₂]jOR²

where R¹ and R² represent linear or branched chain, saturated or unsaturated, aliphatic or aromatic hydrocarbon groups with about 1 to about 30 carbon atoms, R³ represents a group selected from the group comprising a hydrogen atom or a methyl, ethyl, n-propyl, iso-propyl, n-butyl, 2-butyl or 2-methyl-2-butyl group, x is a value between about 1 and about 30, between about 1 and about 20, or between about 6 and about 15, and, k and j are values between about 1 and about 12, between about 1 and about 5, or k may be about 1 and j may be about 1. When the value of x is greater than about 2, each R³ in the formula above may be different. R¹ and R² may be linear or branched chains, saturated or unsaturated, aliphatic or aromatic hydrocarbon groups with about 6 to about 22 carbon atoms, or about 8 to about 18 carbon atoms.

As described above, where the value of x is greater than about 2, each R³ in the formula can be different. For example, when x=3, R³ may be ethylene oxide (EO) (R³ ═H) or propylene oxide (PO) (R³=methyl) units which can be used in any order, for example an order selected from the group comprising (PO)(EO)(EO), (EO)(PO)(EO), (EO)(EO)(PO), (EO)(EO)(EO), (PO)(EO)(PO), (PO)(PO)(EO) and (PO)(PO)(PO).

The detergent formulation may comprise a non-ionic surfactant comprising a mixture of alkoxylated alcohols and hydroxy-group containing alkoxylated alcohols.

The at least one surfactant may be present in a total amount of between about 5.0 and about 30.0 wt. %, between about 7.5 and about 27.5 wt. %, between about 10.0 and about 25.0 wt. %, between about 12.5 and about 22.5 wt. %, between about 15.0 and about 20.0 wt. %, or about 17.5 wt. %, based on the total weight of the detergent formulation.

The at least one surfactant may be present in a total amount of at least about 5 wt. %, about 7.5 wt. %, about 10.0 wt. %, about 12.5 wt. %, about 15.0 wt. %, about 17.5 wt. %, about 20.0 wt. %, about 22.5 wt. %, about 25.0 wt. %, about 27.5 wt. %, or at least about 30 wt. % based on the total weight of the detergent formulation.

The at least one surfactant may be present in a total amount of no more than about 5 wt. %, about 7.5 wt. %, about 10.0 wt. %, about 12.5 wt. %, about 15.0 wt. %, about 17.5 wt. %, about 20.0 wt. %, about 22.5 wt. %, about 25.0 wt. %, about 27.5 wt. %, or no more than about 30 wt. % based on the total weight of the detergent formulation.

The detergent formulation according to the second aspect may optionally include any of the optional features of the invention according to the first aspect.

According to a third aspect of the invention, there is provided a package or device containing the polysaccharide according to the first aspect of the invention, or the detergent formulation according to the second aspect of the invention.

The package or device may be a multi-compartment capsule or container. The multi-compartment capsule or container may comprise 2 or more, 3 or more, or 4 or more compartments. The polysaccharide or detergent formulation may be located in at least one compartment.

The at least one compartment which comprises the polysaccharide or detergent formulation may further comprise a solid formulation comprising one or more cleaning actives, or a liquid formulation comprising one or more cleaning actives, or a gel formulation comprising one or more cleaning actives. Suitable examples of cleaning actives are listed in the section below headed “Cleaning Actives”.

Beneficially, a multi-compartment capsule or container also allows formulations of different forms (i.e. solid form, liquid form or gel form) to be located within different compartments. Such a capsule or container is aesthetically more appealing to consumers and provides advantages with regard to handling, and neat and space-saving stacking, therefore, facilitating storage of the package or device as may be required for e-commerce distribution, for example.

The package may comprise a water-soluble capsule or container. The water-soluble capsule or container may comprise a poly(vinyl alcohol) (PVOH) capsule or container, preferably a thermoformed polyvinyl alcohol capsule or container, especially a thermoformed polyvinyl alcohol multi-compartment capsule or container. The water-soluble container or capsule may comprise a polyvinyl alcohol co-polymer capsule or container.

The water-soluble capsule or container may comprise or be a water-soluble film. The water-soluble film may be rigid or flexible at room temperature.

Preferably, the water-soluble capsule or container comprises or is made of a PVOH film. The PVOH film may be partially or fully alcoholised or hydrolysed, for example, it may be from 40 to 100%, preferably 70 to 92%, most preferably about 85% to about 92%, alcoholised or hydrolysed, polyvinyl acetate film. The degree of hydrolysis is known to influence the temperature at which the PVOH starts to dissolve in water. 88% hydrolysis corresponds to a film soluble in cold (i.e. room temperature) water, whereas 92% hydrolysis corresponds to a film soluble in warm water. The film may be cast, blown or extruded. It may further be unoriented, mono-axially oriented or bi-axially oriented.

The PVOH film may be a thermoformed PVOH film.

The water-soluble capsule or container may be a multi-compartment water-soluble capsule or container. The multi-compartment water-soluble capsule or container may comprise two or more, three or more, four or more, five or more, or six or more separated compartments. Each of the compartments may be arranged side-by-side, concentrically, as sectors of a circle or in any suitable random or organised pattern. The capsule or container may comprise a first PVOH film comprising a pocket and a surrounding flange, and a second PVOH film, applied as a cover across the pocket and sealed across the flange. The detergent formulation may be located in the pocket. The capsule or container may comprise a first PVOH film comprising more than one pocket, for example two or more, three or more, four or more, five or more, or six or more pockets, and a surrounding flange, and a second PVOH film, applied as a cover across each pocket and sealed across the flange. In some embodiments there are three or four pockets.

In some embodiments the package comprises a multiple-compartment capsule or container comprising at least one compartment filled with a polysaccharide of the first aspect of the invention or a detergent formulation of the second aspect of the invention, and at least one further compartment filed with at least one detergent ingredient or detergent formulation. In some embodiments, at least one compartment is filled with a polysaccharide of the invention and at least two further compartments are filled with different detergent ingredients or detergent formulations.

In embodiments of the second aspect of the invention comprising a builder, the builder and the polysaccharide of the first aspect may be mixed with other ingredients or may be separated therefrom. For example, the package or device may take the form of a multi-compartment capsule or container and the builder and polysaccharide may be mixed together and located in one compartment with the remainder of any optional ingredients located in one or more other compartments; the builder may be located in one compartment, the polysaccharide located in another compartment and the remainder of other optional ingredients located in one or more other compartments; or the builder and polysaccharide may be mixed together or separately with other optional ingredients in two or more compartments.

In other embodiments, the device may comprise a reservoir of the polysaccharide or detergent formulation of the first or second aspects of the invention, respectively, and at least one dispensing aperture through which the polysaccharide or detergent formulation is ejected. The dispensing aperture may dispense the polysaccharide or detergent formulation continuously or at defined or timed intervals, or may be arranged to dispense the polysaccharide or detergent formulation at a particular stage of the wash cycle, for example during the pre-wash and/or during the main wash, or after the main wash, when used in automatic dishwashing applications.

The package may comprise a unit-dose format for a single use. In case of a dose for a single wash cycle, the packages of the present invention may contain at least about 0.1 g, about 0.2 g, about 0.3 g, about 0.4 g, about 0.5 g, about 0.6 g, about 0.7 g, about 0.8 g, about 0.9 g, about 1.0 g, about 1.5 g, about 2.0 g, about 2.5 g, about 3.0 g, about 3.5 g, about 4.0 g, about 4.5 g, about 5.0 g, about 5.5 g, about 6.0 g, about 6.5 g, about 7.0 g, about 7.5 g, about 8.0 g, about 8.5 g, about 9.0 g, about 9.5 g, or at least about 10.0 g, of polysaccharide or detergent formulation, such as from about 1.0 to about 50.0 g, especially from about 5.0 g to about 30.0 g, in particular between about 10.0 g and about 25.0 g. Other ingredients may be used as fillers to reach the intended amount. These fillers may be as described herein, and may be powders like sodium sulfates, crystals like sugar, liquids like water or other liquids, and the like. Further auxiliary ingredients like fragrance or dyes can also be used in such a single wash dose.

In embodiments where the polysaccharide or detergent formulation of the invention are used in dishwashing or laundry applications, the package or device may comprise a multi-cycles package or device; that is, the package or device may be structured to release the polysaccharide or detergent formulation of the invention across multiple cycles of washing, and may be added to a dishwasher or laundry washing machine and left for multiple cycles or may be removed and replaced for each cycle. The multi-cycles package or device may comprise a plurality of doses of the polysaccharide or detergent formulation of the invention. The plurality of doses may be arranged to release one dose at any defined time period, such as once every wash cycles, once every stage in every wash cycle or at two or more stages in every wash cycle, for example. The multi-cycle device may comprise a block of the polysaccharide or detergent formulation of the invention in solid form which is arranged to dissolve in use to release a dose of additive at the desired time(s) during each cycle. If the package or device comprises a multi-cycles block, capsule, or gadget, for each dishwashing cycle it may comprise for example between 1 to 20 g of a formulation containing sufficient amounts of the inventive polysaccharide for providing consumer-related benefits, in particular preventing, or significantly reducing, the formation of limescale.

The package or device according to the third aspect may optionally include any of the optional features of the invention according to the first or second aspect.

According to a fourth aspect of the invention, there is provided a method of treating or washing kitchenware in a dishwashing machine, wherein a polysaccharide according to the first aspect of the invention, a detergent formulation according to the second aspect of the invention, or a package or device according to the third aspect of the invention, is added to the dishwashing machine.

The dishwashing machine may be an automatic dishwashing machine.

The method of the fourth aspect, in some embodiments, may comprise, in any order, adding the polysaccharide of the first aspect to the wash fluid of the dishwashing machine, and separately adding the remaining ingredients of a dishwashing detergent formulation to the wash fluid of the dishwashing machine. For example, the method may comprise adding the polysaccharide before or after adding the remaining ingredients. This may be achieved by providing a multi-compartment package of the invention, in which the polysaccharide is in a separate compartment of a water-soluble package to the remaining ingredients, said separate compartment being configured to dissolve before or after the other compartment or compartments (or at least one other compartment), during a wash cycle. Or may be achieved by providing the inventive polysaccharide into the prewash and/or beginning of the main wash, and/or into any other step of the washing process before or after a state of the art detergent or detergent ingredients is/are dispensed.

The method for treating or washing kitchenware in a dishwashing machine may comprise adding the polysaccharide of the first aspect of the invention, the detergent formulation according to the invention in its second aspect, or a package or device according to the invention in its third aspect, to the dishwashing machine at the start of a main wash cycle, the pre-wash cycle or at the start of the final rinse cycle (or any combination thereof).

The invention according to the fourth aspect may optionally include any of the optional features of the invention according to any of the former aspects.

According to a fifth aspect of the invention, there is provided the use of a polysaccharide according to the first aspect of the invention as a sequestering agent or as a limescale inhibitor.

By ‘sequestering agent’, we mean that the polysaccharide of the first aspect of the invention is able to sequester positive cations, such as magnesium and calcium cations, in a washing liquor and prevent the cations from depositing as salts (for example, carbonates, such as limescale, and silicates) on any articles being washed.

By ‘limescale inhibitor’, we mean that the polysaccharide of the first aspect of the invention prevents, or at least significantly reduces, limescale formation in a wash liquor.

The use may be for preventing, or at least significantly reducing, limescale formation on kitchenware made of, or comprising an element made of, glass, such as drinking cups and vessels, baking dishes, mixing bowls and airtight containers. The use may be for preventing, or at least significantly reducing, limescale formation on kitchenware during a wash cycle of an automatic dishwasher.

The invention according to the fifth aspect may optionally include any of the optional features of the invention according to any of the former aspects.

According to a sixth aspect of the invention, there is provided the use of a polysaccharide according to the first aspect, a detergent formulation according to the second aspect, or a package or device according to the third aspect, for domestic cleaning or treatment, including automatic dishwashing, hard surface cleaning, water treatment and laundry washing.

Hard surface cleaning may comprise the cleaning of an element made of glass, for example windows.

The invention according to the sixth aspect may optionally include any of the optional features of the invention according to any of the former aspects.

The polysaccharide of the invention made be synthesised according to any polysaccharide functionalisation techniques as known in the art, such techniques are described in, for example, T. Heinze, 2018, Cellulose Derivatives, Synthesis, Structure and Properties, Springer Series on Polymer and Composite Materials, Springer, ISBN 978-3-319-73167-4, which also describes suitable techniques for sulfoethylation and carboxymethylation.

One or more of the following cleaning active categories may be present in the detergent formulation of the second aspect of the invention or in any detergent located in any compartment of a multi-compartment package or device of the invention, as desired. More than one ingredient from each cleaning active category may be present, if a cleaning active category is present in the detergent formulation, package or device of the invention.

### Cleaning Actives

If the inventive polysaccharide may be used as part of a dishwashing detergent, it can be used in combination with their state of the art ingredients. Those skilled in the art will appreciate that where the term “detergent” is used herein, this does also include rinse aid and other additive compositions used to be applied during dishwashing in a dishwasher. The polysaccharide or the detergent formulation may comprise one or more active components which may be selected from surfactants, alkalinity sources, acidity sources (especially for rinse aid and machine cleaner), builders, enzymes, polymers, anti-corrosion agents, bleach, care agents and other auxiliary ingredients like fragrance, dye, etc.

The detergent formulation may comprise any ingredients known in the art.

### Builder

The detergent formulation may comprise one or more builder(s) in addition to the builder of the present invention. The builder may be either a phosphate-containing builder or a phosphate-free builder, or a mixture of each, as desired. In many countries, including the United States and in the European Union, phosphate builders are restricted and so phosphate-free builders are preferred.

The phosphate-free builder may also or alternatively comprise non-polymeric organic molecules with one or more carboxylic group(s). Builder compounds which are organic molecules comprising carboxylic groups may include citric acid, fumaric acid, tartaric acid, maleic acid, lactic acid and salts thereof. The alkali or alkaline earth metal salts of these organic compounds may be used, in particular, but not limited to, the sodium salts. The phosphate-free builder may be sodium citrate.

The phosphate-free co-builder may be one or more polycarboxylate(s) which comprise two carboxyl groups, for example, water-soluble salts of, malonic acid, (ethylenedioxy)diacetic acid, maleic acid, diglycolic acid, tartaric acid, tartronic acid and fumaric acid. The phosphate-free co-builder may be one or more polycarboxylate(s) which comprise three carboxyl groups, for example, water-soluble citrate. The phosphate-free co-builder may be one or more hydroxycarboxylic acid, for example, citric acid.

If phosphate-containing builders are to be used, the phosphate-containing builder may be selected from one or more of phosphonates, for example 1-Hydroxyethylidene-1,1-diphosphonic acid (HEDP), monophosphates, di-phosphates, tri-polyphosphates or oligomeric-poylphosphates, or its alkali metal salt, in particular, but not limited to, its sodium salt, for example sodium tripolyphosphate (STPP).

Conventional amounts of the phosphate-containing builders may be used, typically in the range of from 15% by weight to 70% by weight, or from 20% by weight to 60% by weight, or from 25% by weight to 50% by weight. If additional phosphate-free builder is included, the phosphate-free builder may be chosen from succinate based compounds. It is intended that the term ‘succinate based compound’ includes succinic acid based compounds, and such terms may be used interchangeably herein. Conventional amounts of the succinate based compounds may be used, typically in the range of from 5% by weight to 80% by weight, or from 15% by weight to 70% by weight, or from 20% by weight to 60% by weight. The compounds may be used individually or as a mixture.

The detergent formulation may include other suitable builders, for example, glutamic acid N,N-diacetic acid (GLDA), methylglycinediacetic acid (MGDA). aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), a-alanine-N,N-diacetic acid (a-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N, N-diacetic acid (ANDA), sulfanilic acid-N, N-diacetic acid (SLDA), taurine-N, N-diacetic acid (TUDA) and sulfomethyl-N, N-diacetic acid (SMDA), tetrasodium iminosuccinate, iminodisuccinic acid (IDS) and (hydroxy)iminodisuccinic acid (HIDS) and alkali metal salts or ammonium salts thereof, or mixtures thereof.

The builder may comprise homopolymers and copolymers of polycarboxylic acids and their partially or completely neutralised salts, monomeric polycarboxylic acids and hydroxycarboxylic acids and their salts, phosphates and phosphonates, and mixtures thereof. The salts of the abovementioned compounds may be the ammonium and/or alkali metal salts, i.e. the lithium, sodium, or potassium salt.

The builder may be an organic builder.

The total amount of builder present in the detergent formulation may be at least 5% by weight, at least 10% by weight, at least 15% by weight, at least 20% by weight, at least 25% by weight, at least 30% by weight, at least 35% by weight, at least 40% by weight, at least 45% by weight, or at least 50% by weight.

The total amount of builder present in the detergent formulation may be in an amount of up to 80% by weight, up to 70% by weight, up to 60% by weight, up to 50% by weight, or up to 45% by weight. The actual amount used in the detergent formulation may depend upon the nature of the builder used.

### Surfactant

The detergent formulation may include one or more surfactant(s). The surfactant may be any of non-ionic, anionic, cationic, amphoteric or zwitterionic surface active agents, or suitable mixtures thereof. Preferably, the surfactant is a non-ionic surfactant. The non-ionic surfactant may be an ethoxylated non-ionic surfactant prepared by the reaction of a monohydroxy alkanol with 6 to 20 carbon atoms. The surfactant may have at least 12 moles, at least 16 moles, at least 20 moles, or at least 25 moles, of ethylene oxide per mole of alcohol. The non-ionic surfactant may be from a linear chain fatty alcohol with 16-20 carbon atoms and at least 12 moles, at least 16 moles, or at least 20 moles, of ethylene oxide per mole of alcohol.

The non-ionic surfactant may additionally comprise propylene oxide units in the surfactant molecule. The propylene oxide units may constitute up to 25% by weight, up to 20% by weight, or up to 15% by weight of the overall molecular weight of the non-ionic surfactant.

The surfactant may be an ethoxylated mono-hydroxy alkanols which additionally comprise polyoxyethylene-polyoxypropylene block copolymer units. The alcohol portion of the ethoxylated mono-hydroxy alkanols may constitute more than 30% by weight, more than 50% by weight, or more than 70% by weight of the overall molecular weight of the non-ionic surfactant. The non-ionic surfactant may comprise reverse block copolymers of polyoxyethylene and polyoxypropylene and block copolymers of polyoxyethylene and polyoxypropylene initiated with trimethylolpropane.

The non-ionic surfactant may be a surfactant described by the formula:

R¹O[CH₂CH(CH₃)O]X[CH₂CH₂O]Y[CH₂CH(OH)R²]

where R¹ represents a linear or branched chain aliphatic hydrocarbon group with 4-18 carbon atoms or a mixture thereof, R² represents a linear or branched chain aliphatic hydrocarbon rest with 2-26 carbon atoms or a mixture thereof, x is a value between 0.5 and 1.5, and y is a value of at least 15.

The non-ionic surfactant may be an end-capped polyoxyalkylated non-ionic surfactant of the formula:

R¹O[CH₂CH(R³)O]X[CH₂]kCH(OH)[CH₂]jOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5, more preferably k=1 and j=1. When the value of x is greater than 2, each R³ in the formula above may be different. R¹ and R² are preferably linear or branched chain, saturated or unsaturated, aliphatic or aromatic hydrocarbon groups with 6-22 carbon atoms, preferably 8 to 18 carbon atoms. For the group R³, H, methyl or ethyl is particularly preferred. Particularly preferred values for x are comprised between 1 and 20, preferably between 6 and 15.

As described above, where the value of x is greater than 2, each R³ in the formula can be different. For example, when x=3, R³ may be ethylene oxide (EO)(R³ ═H) or propylene oxide (PO)(R³=methyl) units which can be used in any order, for example (PO)(EO)(EO), (EO)(PO)(EO), (EO)(EO)(PO), (EO)(EO)(EO), (PO)(EO)(PO), (PO)(PO)(EO) and (PO)(PO)(PO).

The detergent formulation may comprise a non-ionic surfactant comprising a mixture of alkoxylated alcohols and hydroxy-group containing alkoxylated alcohols.

The detergent formulation may comprise a non-ionic surfactant in an amount of from 0.1% by weight to 20% by weight, 1% by weight to 15% by weight, or 2% to 10% by weight, based on the total weight of the detergent formulation.

### Enzyme

The detergent formulation may comprise one or more enzyme(s). The enzyme may be selected from the group containing protease, lipase, amylase, cellulase and peroxidase, or mixtures thereof. Preferably, the enzyme may be protease or amylase, or a mixture thereof. Advantageously, enzymes, in particular, but not limited to, protease and amylase, are especially effective in providing favourable cleaning efficacy in dishwashing detergent formulations. Any suitable species of these enzymes may be used as desired. More than one species may be used.

The detergent formulation may comprise at least 0.001 mg, at least 0.01 mg, or at least 0.1 mg of active enzyme per gram of detergent formulation.

The detergent formulation may comprise from about 1.5 to about 10 mg, from about 1.8 to about 5 mg, or from about 2 to about 4 mg of active enzyme per gram of detergent formulation.

### Bleach

The detergent formulation may comprise at least one bleach additive or bleach activation catalyst. The at least one bleach additive or bleach activation catalyst may be selected from the group comprising an organic peracid, for example perbenzoic acid and peroxycarboxylic acids e.g. phthalimido peroxy caproic acid (PAP).

Advantageously, organic peracids do not require the use of a bleach activator or catalyst as these bleaches are active at relatively low temperatures, for example at about 30° C. and this contributes to such bleach materials being preferred according to the present invention.

The detergent formulation may comprise one or more bleaching agents. The one or more bleaching agents may be selected from the group comprising a percarbonate, for example coated sodium percarbonate or uncoated sodium percarbonate, and peroxycarboxylic acids e.g. phthalimido peroxy caproic acid (PAP).

The detergent formulation may comprise one or more bleach activator. The one or more bleach activator may be tetraacetylethylenediamine (TAED), Sodium nonanoyloxybenzenesulfonate (NOBS) or sodium decanoyloxybenzene sulfonic acid (DOBS).

The detergent formulation may comprise one or more bleach catalyst. The one or more bleach catalyst may be a manganese complex comprising triazacyclononane (TACN), or any derivatives of a TACN ligand, for example 1,4,7-trimethyl-TACN, or manganese oxalate, manganese acetate or a dinuclear manganese complex, for example a dinuclear manganese complex comprising TACN or any derivatives of a TACN ligand, for example 1,4,7-trimethyl-TACN, or mixtures thereof.

The detergent formulation may comprise one or more bleach activator or bleach catalyst, dependent on the nature of the bleaching compound. The bleach activator may be Tetraacetylethylenediamine (TAED). The bleach catalyst may be selected from the group comprising manganese oxalate, manganese acetate, manganese sulfate, or a manganese salt thereof, or a dinuclear manganese complex.

The detergent formulation may comprise water.

### Acidity and Alkalinity

The detergent formulation may comprise a source of acidity or a source of alkalinity, to obtain the desired pH on dissolution. A source of acidity may be any acidic compound, for example a polycarboxylic acid, for example citric acid. A source of alkalinity may be a carbonate or bicarbonate (such as an alkali metal or alkaline earth metal salt). A source of alkalinity may be any basic compound, for example any salt of a strong base and a weak acid. Non-limiting examples of an alkalinity source include an alkali hydroxide, alkali hydride, alkali oxide, alkali sesquicarbonate, alkali carbonate, alkali borate, alkali salt of mineral acid, alkali amine, alkaloid, or mixtures thereof. The alkalinity source may be sodium carbonate, sodium hydroxide or potassium hydroxide. The source of alkalinity may be present in an amount sufficient to give the wash liquor a pH of from about 8 to about 12, preferably from about 9 to about 11.5. The detergent formulation may comprise from about 1% to about 40%, or from about 2% to 20% by weight of the formulation, of a source of alkalinity.

The source of alkalinity may comprise a source of univalent ions. Beneficially, univalent ions contribute to high alkalinity and, advantageously, only minimally raise the ionic strength of the wash solution. The alkalinity source may be a metal hydroxide, for example, sodium or potassium hydroxide.

### Anti-Corrosion Agent

The detergent formulation may comprise one or more anti-corrosion agent(s). Anti-corrosion agents may provide further benefits against corrosion of glass and/or metal and the term encompasses agents that are intended to prevent or reduce the tarnishing of non-ferrous metals, in particular of silver and copper.

The detergent formulation may comprise multivalent ions, for example zinc, bismuth and/or manganese ions. Beneficially, these multivalent ions may further inhibit corrosion of glass and/or metal.

The detergent formulation may comprise polymers for inhibit corrosion of glass and/or metal like polyalkylenimmines and/or polyquats.

The detergent formulation may comprise organic and inorganic redox-active substances which are known as suitable for use as silver/copper corrosion inhibitors. The inorganic redox-active substances may be metal salts and/or metal complexes chosen from the group consisting of zinc, bismuth, manganese, titanium, zirconium, hafnium, vanadium, cobalt and cerium salts and/or complexes thereof, the metals being in one of the oxidation states II, III, IV, V or VI. The metal salts and/or metal complexes may be chosen from the group consisting of MnSO₄, Mn(ll) citrate, Mn(ll) stearate, Mn(ll) acetylacetonate, Mn(ll) [1-hydroxyethane-1,1-diphosphonate], V₂O₅, V₂O, VO₂, TiOSO₄, K₂TiF₆, K₂ZrF₆, CoSO₄, Co(NO₃)₂, zinc acetate, zinc sulfate and Ce(NO₃)₂. The source of multivalent ions may be chosen from sulfates, carbonates, acetates, gluconates and metal-protein compounds.

The detergent formulation may comprise one or more silver/copper anti-corrosion agent(s), for example benzotriazole (BTA) or bis-benzotriazole, or substituted derivatives thereof, for example tolyltriazole. Benzotriazole derivatives are those compounds in which the available substitution sites on the aromatic ring are partially or completely substituted, for example linear or branch-chain C1-20 alkyl groups and hydroxyl, thio, phenyl or halogen such as fluorine, chlorine, bromine and iodine.

The detergent formulation may comprise an anti-corrosion agent in an amount of from 0.01% by weight to 5% by weight, 0.05% by weight to 3% by weight, 0.1% by weight to 2.5% by weight, or 0.2% by weight to 2% by weight, based on the total weight.

### Polymer

The detergent formulation may comprise one or more polymer(s) in addition to the polysaccharide of the present invention. Beneficially, one or more polymer(s) may improve the cleaning performance of the detergent formulation. The polymer may be a sulfonated polymer. The polymer may be a copolymer. The copolymer may be a copolymer of

CH₂═CR¹—CR²R³—O—C₄H₃R⁴—SO₃X

where R¹, R², R³ and R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene, or mixtures thereof.

The (co) polymer may include sulfonated monomer units, for example 2-acrylamido-2-methyl-1-propanesulfonic acid, 2-methacrylamido-2-methyl-1-propanesulfonic acid, 3-methacrylamido-2-hydroxy-propanesulfonic acid, allysulfonic acid, methallysulfonic acid, 2-hydroxy-3-(2-propenyloxy) propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof, or mixtures thereof.

The detergent formulation may comprise a sulfonated polymer in an amount of at least 0.1% by weight, at least 0.5% by weight, at least 1% by weight, at least 3% by weight, or up to 40% by weight, up to 25% by weight, up to 15% by weight, or up to 10% by weight.

### Foam Control Agent

The detergent formulation may comprise one or more foam control agent(s). The one or more foam control agent(s) may be any conventionally used in this field, for example silicones and their derivatives, or paraffin oil, or mixtures thereof. The foam control agent may be present in an amount of 0.5% by weight or less.

### Preservative

The detergent formulation may comprise minor, conventional, amounts of one or more preservative(s).

### Auxiliary

The detergent formulation may comprise auxiliary ingredients like for example, fragrance, dye, etc.

### EXAMPLES

### Example 1—Sequestering Agent

Example 1 was carried out using maltodextrin functionalised through ether linkages via oxygen atoms from hydroxyl groups of the maltodextrin, with carboxymethyl groups (—CH₂—C(O)OH) and with sulfoethyl sodium salt groups (-Et-SO₃⁻Na⁺), i.e. carboxymethylsulfoethyl maltodextrin (Compound 1).

The carboxymethyl group-functionalised maltodextrin backbone portions had the formula:

P—O¹—CH₂—C(O)OH
and the sulfoethyl sodium salt group-functionalised maltodextrin backbone portions had the formula:

P—O¹-Et-SO₃⁻Na⁺
wherein P is the maltodextrin backbone and 01 is an oxygen atom of a hydroxyl group on the maltodextrin backbone, P.

The carboxymethyl groups and sulfoethyl sodium salt groups were present in a ratio of 4:1, respectively.

Before functionalisation with the carboxymethyl and sulfoethyl sodium salt groups, the maltodextrin had an average molecular weight of 10 kDa.

Each of the carboxymethyl groups and sulfoethyl sodium salt groups were bonded to maltodextrin via an etherification reaction bonding each group to an oxygen atom of a hydroxyl group of the maltodextrin backbone.

Two detergent formulations, Inventive Formulation 1 and Comparative Formulation 1, were prepared according to the following formulations:

| | | Inventive | Comparative |
|---|---|---|---|
| Function | Ingredient | Formulation 1 | Formulation 1 |
| Builder | Citrate Dihydrate | 17.0 | 17.0 |
| (wt. %) | | | |
| Co-Builder | Phosphonate (HEDP) | 6.0 | 6.0 |
| (wt. %) | | | |
| Alkali (wt. %) | Sodium Carbonate | 30.0 | 30.0 |
| Enzyme | Granular Protease | 1.0 | 1.0 |
| (wt. %) | Granular Amylase | 1.0 | 1.0 |
| Bleaching | Bleach Actives | 18.0 | 18.0 |
| System | | | |
| (wt. %) | | | |
| Surfactant | Fatty Alcohol | 18.0 | 18.0 |
| (wt. %) | Alkoxylate (EO/PO) | | |
| Sequestering | Compound 1 | 5.0 | 0.0 |
| Agent (wt. %) | Polyacrylate/Acrylamide | 0.0 | 5.0 |
| | Co-polymer | | |
| Binder | Polyglycol Thickening | 3.5 | 3.5 |
| (wt. %) | Agent | | |
| Auxiliary | Silver Corrosion | 0.5 | 0.5 |
| (wt. %) | Protection Agent (e.g. | | |
| | Benzotriazole) | | |
| | Glass Protection Agent | | |
| | (e.g. Nitrogen- | | |
| | Containing Polymer or | | |
| | Zinc Salt) | | |
| | Anti-Foaming Agent | | |

Each Formulation was in the form of a compressed powder.

Each formulation was packaged in a separate water-soluble package made of PVOH.

The ingredients of each Formulation were identical, with the exception that Inventive Formulation 1 comprised 5.0 wt. % of Compound 1 and no Polyacrylate/Acrylamide Co-polymer, and Comparative Formulation 1 comprised no Compound 1 and 5.0 wt. % of Polyacrylate/Acrylamide Co-polymer.

Notably, Inventive Formulation 1 provided an improvement in filming and spotting tests in the context of limescale formation on kitchenware articles washed in an automatic dishwasher, compared to Comparative Formulation 1 comprising a conventional Polyacrylate/Acrylamide Co-polymer.

It was therefore found that a detergent formulation comprising Compound 1 effectively sequesters positive cations, such as magnesium and calcium cations, and maintains the solubility of the formed adducts, therefore preventing the cations from depositing as salts, such as carbonate (e.g. limescale), phosphonate and silicate on the articles being washed. As such, Inventive Formulation 1, comprising the inventive polysaccharide, therefore, reduces limescale formation to a greater extent compared to Comparative Formulation 1.

Moreover, Inventive Formulation 1 provided a reduction in discolouration and shine loss of kitchenware articles compared to that of articles washed using Comparative Formulation 1.

Further, as Inventive Formulation 1 did not comprise a Polyacrylate/Acrylamide Co-polymer, but instead comprised Compound 1, Inventive Formulation 1 exhibits a more favourable environmental performance profile compared to Comparative Formulation 1 which relies on a synthetic Polyacrylate/Acrylamide Co-polymer.

Further Filming Experiments have been Executed with Different Standard Automatic Dishwashing Compositions According to the Following Table:

| Falcon EU | | | | | | | | |
|---|---|---|---|---|---|---|---|---|
| detergent | Filming | | | | | | | |
| composition | Short | | | | Long | | | |
| comprising | G | SS | PO | PP | G | SS | PO | PP |
| RFS22_23 | 3.8 | 3.0 | 3.0 | 3.0 | 5.0 | 5.0 | 4.0 | 3.5 |
| MD07CM2 | 4.1 | 3.0 | 4.0 | 3.0 | 5.0 | 5.0 | 4.5 | 3.5 |
| No added | 4.0 | 4.0 | 3.0 | 3.0 | 5.0 | 5.0 | 4.5 | 3.5 |
| polysaccharides* | | | | | | | | |
| Alcoguard | 4.3 | 4.5 | 3.5 | 3.0 | 5.0 | 5.0 | 3.5 | 4.0 |
| H5941* | | | | | | | | |

*Comparative examples: Herein, the third example is not comprising any polysaccharide at all in the detergent composition.

The first two detergent compositions represent inventive examples due to the presence of a respective polysaccharide covered by the claims of the present invention.

Herein, the inventive polysaccharides comprise the following properties:

| | | Degree of | Degree of | Total |
|---|---|---|---|---|
| | | substitution | substitution | degree of |
| | Mw | carboxymethyl | sulfoethyl | functional- |
| Polysaccharide | [kDa] | groups | groups | ization |
| RFS22_23 | 3.2 | 1.3 | 0.2 | 1.5 |
| MD07CM2 | 3.2 | 1.2 | — | 1.2 |

MD07 CM2 is not comprising any sulfur containing groups such as sulfonate groups, therefore there is no functionalization possible by sulfur containing groups.

In the following, the synthetic route is given for both polymers:

### Synthesis of Sulfoethyl-Carboxymethyl Maltodextrin (DE=4-7), SE-CM-MD One-Pot Procedure (RFS22_23)

Maltodextrin (50 g, 310 mmol AGU) and NaOH (52.2 g, powdered, 1.31 mol) were placed in a 2 L-round bottom flask equipped with a magnetic stirbar. Isopropanol (1 L) was added and the resulting suspension was stirred vigorously. Deionized water (92.5 mL) was slowly added in 2 mL portions. After addition of about 50% of the water, the maltodextrin precipitated as sticky lumps, almost preventing stirring. The reaction pale yellow mixture was heated at 50° C. for 16 hrs. The swollen, now dark yellow maltodextrin lumps were loosened with a spatula and stirred for 3 more hours at 50° C. Sodium monochloroacetate (125 g, 1.07 mol) was added as a solid. Stirring was initially impaired, but picked up again after some time. The reaction mixture was heated at 50° C. for 5 hrs, during which the maltodextrin turned into a pale brown, sticky paste which rendered stirring impossible again. Sodium vinyl sulfonate solution (25 wt % in water, 240 g soln, 60 g, 0.46 mol NaVS) was added and heating was increased to 80° C. The reaction mixture was heated at 80° C. for 16 hrs. After cooling to ambient temperature, the isopropanol layer was decanted leaving a dark oil. The oil was dissolved in deionized water (200 mL) and triturated with methanol (2.5 L) to afford an off-white precipitate. The precipitate was separated by filtration, washed on the filter with additional methanol (2×500 mL) and dried under vacuum at 50 to give 76 g off-white, hygroscopic powder. DSCM=1.3, DSSE=0.2.

### Synthesis of Carboxymethyl Maltodextrin (DE=4-7), SE-MD Two-Pot Procedure (MD07_CM2)

Maltodextrin (50 g, 310 mmol AGU) and NaOH (50 g, powdered, 1.25 mol) were placed in a 2 L-round bottom flask equipped with a magnetic stirbar. Isopropanol (1 L) was added and the resulting suspension was stirred vigorously. Deionized water (92.5 mL) was slowly added. After addition of the water, the maltodextrin precipitated as sticky lumps, almost preventing stirring. The reaction pale yellow mixture was heated at 50° C. for 16 hrs. Sodium monochloroacetate (125 g, 1.07 mol) was added as a solid in small portions. After each addition of the solid, the reaction mixture was stirred with a spatula. After this, the MD formed a light brown sticky solid at the bottom of the flask. The reaction mixture was heated to 50° C. After about 1 hrs, stirring became easier. The reaction mixture was heated at 50° C. for 5 hrs. After which, the iPrOH layer was decanted and the residue was dissolved in demineralized water (350 mL). The aqueous solution was acidified with an aqueous 50/50 v/v acetic acid solution to pH 6. This solution was precipitated in methanol (2.5 L) and the precipitate was collected on a P3 glass filter. The crude product was washed on the filter with methanol (2×500 mL) and dried at 50° C. under vacuum for 16 hrs. Yield: 61 g off-white, hygroscopic powder. DSCM=0.8.

In order to increase the DS value, the product was submitted to a second carboxymethylation reaction following the same procedure. After decanting the iPrOH layer, the product was dissolved in water. Because the solution was turbid, it was first filtered on a P3 glass filter and the solid phase was discarded. The now clear solution was acidified with an aqueous 50/50 v/v acetic acid solution to pH 6, precipitated in methanol (2.5 L) and washed with methanol (2×500 mL) and dried at 50° C. under vacuum for 16 hrs. Yield: 84 g off-white, hygroscopic powder. DSCM=1.2.

The Shine Performance Experiments have been Executed According to the Following Method:

### Machine

Short Term: Bosch SMS46MW03E/41
Long Term: Miele GSL

### Program

Short Term: Eco
Long Term: 65° C./10 min

### Evaluation by Two Trained Assessors

Short Term: after 5 washing cycles
Long Term: after 20 washing cycles

### Water Hardness: 21° GH

### Soil Load: 16 g Ballast Soil

### Scoring for Filming

5—extremely strong (Least favoured)
4—very strong
3—strong
2—slightly
1—no (Desired outcome)

The one or more embodiments are described above by way of example only. Many variations are possible without departing from the scope of protection afforded by the appended claims.

1. A polysaccharide for a detergent formulation, wherein the polysaccharide comprises a polysaccharide backbone functionalised with carboxylic acid groups, or salts or esters thereof, and sulfur-containing groups, or salts or esters thereof; wherein the polysaccharide backbone is selected from the group comprising, or derived from, maltodextrin, starch and hydrolysed starch.

2. A polysaccharide according to any preceding claim, wherein the polysaccharide has an average molecular weight of between 1 and 50 kDa before functionalisation with the carboxylic acid groups, or salts or esters thereof, and the sulfur-containing groups, or salts or esters thereof.

3. A polysaccharide according to any preceding claim, wherein the carboxylic acid groups, or salts or esters thereof, and the sulfur-containing groups, or salts or esters thereof, are present in a molar ratio of between 4:1 and 1:2.

4. A polysaccharide according to claim 3, wherein the carboxylic acid groups, or salts or esters thereof, and the sulfur-containing groups, or salts or esters thereof, are present in a molar ratio of between 4:1 and 2:1.

5. A polysaccharide according to any preceding claim, wherein the polysaccharide backbone has a total degree of functionalisation of at least about 1.4, and/or a degree of functionalisation by sulfur-containing groups, or salts or esters thereof, of less than about 0.4.

6. A detergent formulation for an automatic dishwashing cycle, the detergent formulation comprising the polysaccharide according to any preceding claim.

7. A detergent formulation according to claim 6, wherein the polysaccharide is present in an amount of between 0.1 and 10.0 wt. %.

8. A detergent formulation according to claim 7, the detergent formulation further comprising a builder in an amount of between 10 and 60 wt. %, a bleaching system in an amount of between about 0 and 30 wt. %, and a surfactant in an amount of between about 5 and about 30 wt. %.

9. A package or device containing the polysaccharide according to any of claims 1 to 5, or the detergent formulation according to any of claims 6 to 8.

10. A package or device according to claim 9, wherein the package or device is a multi-compartment container or capsule, and wherein the detergent formulation is located in at least one compartment.

11. A package or device according to claim 9 or 10, wherein the package or device is a water-soluble container or capsule.

12. A package or device according to claim 11, wherein the water-soluble container or capsule is a polyvinyl alcohol capsule or container or a polyvinyl alcohol co-polymer capsule or container.

13. A method of treating or washing kitchenware in a dishwashing machine, wherein a polysaccharide according to any of claims 1 to 5, a detergent formulation according to any of claims 6 to 8, or a package or device according to any of claims 9 to 12, is added to the dishwashing machine.

14. Use of a polysaccharide according to any of claims 1 to 5 as a sequestering agent or as a limescale inhibitor.

15. Use of a polysaccharide according to any of claims 1 to 5, a detergent formulation according to any of claims 6 to 8, or a package or device according to any of claims 9 to 12, for domestic cleaning or treatment, including automatic dishwashing, hard surface cleaning, water treatment and laundry washing.
